(19) United States
(12) Patent Application Publication
(10) Pub. No.: US 2024/0150619 A1
(43) Pub. Date: May 9, 2024

(54) TAPE FOR MITIGATING PASSIVE INTERMODULATION

(71) Applicant: Vecta Pty Ltd, Castle Hill (AU)

(72) Inventors: Gregory Rex DELFORCE, Castle Hill (AU); Frank John STRACHAN, Castle Hill (AU)

(21) Appl. No.: 18/032,774

(22) PCT Filed: Aug. 24, 2021
(86) PCT No.: PCT/AU2021/050947

§ 371 Date: Apr. 19, 2023

(30) Foreign Application Priority Data
Oct. 20, 2020 (AU) 2020903789

(51) Int. Cl. C09J 7/25; C09J 7/38; H01Q 1/52

(52) U.S. Cl. CPC C09J 7/255; C09J 7/38; H01Q 1/526; C09J 2203/306; C09J 2203/346; C09J 2301/122; C09J 2301/18; C09J 2301/302; C09J 2400/163; C09J 2467/006

(57) ABSTRACT

Tape for mitigating passive intermodulation, the tape including: a metalized polymer substrate; an adhesive layer bonded to a first face of the substrate; and, a plurality of apertures extending through the substrate and the adhesive layer, such that when the tape is adhered to a surface using the adhesive layer, the apertures allow fluid communication between the surface and a second face of the substrate opposing the first face.

### BACKGROUND OF THE INVENTION

The present invention relates to a tape for mitigating passive intermodulation (“PIM”).

### DESCRIPTION OF THE PRIOR ART

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

In a modern mobile communication network, base stations are a critical element that provide a location for a range of antenna line products including antennas and radio systems, often all mounted in an outdoor environment. Typically, these operate over multiple assigned frequency bands. Much of this equipment is secured to small or large metal structures, depending on the location. Some are roof-top mounted while others are secured to free-standing large towers.

PIM acts as a source of interfering signals and therefore are unwanted in mobile communication networks. Generally, PIM is created when there are two or more transmitted frequencies striking nearby metal structures that are either corroded or have metal to metal junctions. These junctions can behave as non-linear devices and cause the signals striking them to mix in a way that generates a new signal at a very particular frequency.

If these unintended signals occur at a frequency that falls within the receive frequency band of the radio system (“in-band”), then the radio system processes them in the same way as desired signals in the same receive frequency band. There is no easy, effective method to process the in-band unwanted signals any differently from the desired wanted signals and the coexistence of wanted and unwanted signals in the same frequency band degrades the performance of the radio system. The unwanted signal is an interferer caused by externally generated PIM. Since the presence of any external interfering PIM source will lead to degradation of the radio system performance in some characteristic way, the most effective resolution is to eliminate that external PIM interferer. If the mechanism for an unwanted PIM signal to exist is removed, then there can be no PIM interference in the radio system.

The source of externally generated interfering PIM is always located close to an antenna, since the interfering PIM power level must be sufficiently high so as to pass through the free-space distance between the externally generated PIM interferer and the antenna receiving elements, to then be recognised as a significant radio frequency (“RF”) signal in the active receiver circuits. As this distance increases, the strength of the interfering PIM signal reduces greatly, following a well understood behaviour.

PIM barrier tapes (also referred to as PIM shield tapes) are known for use in the management of PIM interference. The purpose of an effective PIM barrier tape is to attenuate signals reaching the PIM generating source by greater than 20 dB, and this will effectively reduce the interfering PIM signal to a level below the noise level threshold within the radio receiver circuits, and therefore presenting no detrimental effects to the mobile system network. The application of any PIM barrier tape or similar material within mobile communication networks can range from being a temporary tool to aid the detection of PIM, to a permanent rectification of external PIM generating sources in the same environment.

As a PIM detection tool, tape is applied to suspect sections of any structure to effectively isolate or remove that element from the RF path, thus eliminating the effects it might have as a generator of unwanted PIM interference. If the previously observed PIM interferer remains when the tape in place, then it can be reasonably assumed that the suspect section of the structure is not a PIM generator. Alternatively, if the PIM interferer is eliminated once the tape is applied, then it can be reasonably assumed that the problem is associated with the section masked by the tape. Removal of the tape will then allow remediation to the section of the structure, through cleansing of surfaces, replacement of material or other well-established PIM mitigation techniques. In this way, the PIM barrier tape is a temporary application and of no further use once removed from the target area. It will be discarded following the one-time use.

PIM barrier tape has also been utilised as a long-term remediation solution, for instance by simply being left in place indefinitely once it has proven to eliminate the PIM interferer. However, it should be noted that, while this method may eliminate the interference caused by PIM, it does not rectify the source of the PIM. As long as the PIM barrier tape remains in place, the weakness is effectively masked, but never eliminated.

Temporary PIM barrier tape solutions need lesser environmental considerations since the life of the application would typically be anything from hours to days and rarely longer than a few weeks, but longer term applications require careful consideration of the suitability of the PIM barrier tape material over years of service in a diverse range of weather and other environmental conditions. Adhesion, solar radiation resistance, moisture and rain resistance and performance characteristics over normal atmospheric temperature extremes are considerations but also, moisture trapping properties and resistance to pest and bird attack (pecking and clawing of the material) may be of critical importance.

However, a user of any PIM barrier tape solution may not be fully aware of the additional environmental requirements necessary for the material to be safe and effective over long periods of application, particularly with regard to corrosive effects arising from moisture trapped under the tape as well as pest and bird attack risks. It is therefore desirable to provide a PIM barrier tape solution that can reduce the likelihood or impact of these problems.

With regard to the construction of conventional PIM barrier tapes, it is well understood in the industry that a single, thin conductive metal layer can be used effectively in some circumstances to mitigate PIM. However, where there is an overlap of the thin conductive layer such that a loose connection between layers occurs, this may generate significant unwanted PIM interfering signals. For this reason, the general concept adopted in conventional solutions is to use a multi-layer structure where the thin conductive metal layer is sandwiched between nonconductive layers, with an adhesive applied to one surface to allow bonding of the tape. This results in a relatively thick multi-layer construction. In use, conventional PIM barrier tapes of this type create a relatively dense, water and moisture sealed, highly adhesive sealed barrier, which is attached to and most often wrapped around steel and other structural members.

Thus, use of these types of conventional PIM barrier tapes in longer term applications may lead to corrosion in the underlying metal structure. Specifically, rainwater or other moisture may be trapped under the tape, along the length of the wrapped section. This trapped moisture could remain for long periods of time, which can cause extensive corrosion to the metal structure over time, potentially leading to structural failure.

U.S. Pat. No. 5,494,755 discloses a tape for seaming together RF shielding thermal blanks of the kind used for covering the metal components of high power RF transmit and receive communications systems which are susceptible to generating passive intermodulation products, such as the high power transmit antenna boom assemblies of communications spacecraft. The tape is constructed as a composite lay-up of materials which preferably include a plastic film top or outboard layer, a metalized plastic film or metal foil middle layer, and a transfer adhesive bottom layer for secure g the middle layer to the outboard layer. The transfer adhesive functions both as a substrate attaching medium and as an electrical isolator for encapsulating the metal surfaces of the middle layer. The tape, when applied to cover a seam between adjacent RF shielding thermal blankets, prevents RF energy from penetrating the seam and contacting any metal-to-metal junctions underneath which could results in the generation of undesirable passive intermodulation products.

US2018/0147812 discloses materials and methods for mitigating passive intermodulation. A membrane for reducing passive intermodulation includes a first polymeric layer, a second polymeric layer, and a continuous metal layer encapsulated between the first and second polymeric layers. A self-adhesive radio frequency barrier tape includes a waterproof polymeric top layer, a metal-containing layer, and a release liner on a bottom surface of the pressure sensitive adhesive layer. A method of mitigating passive intermodulation includes passing a problem over an area of interest, the probe being sensitive of an intermodulation frequency of interest, and identifying a suspecting source of passive intermodulation when the amplitude of the probe output exceeds a threshold at the frequency of interest. The method further includes a covering the suspecting passive intermodulation source with a radio frequency barrier material.

EP 3361571 discloses a thermal multi-layer insulation (MU) and radio-frequency (RF) absorber blanket comprising: an upper layer comprising a patterned frequency-selective structure (FSS) sheet tuned in function of the RF frequencies to be absorbed; one or more intermediate resistive layers for RF absorption; a lower RF ground layer. The upper layer may comprise a polymeric film, in particular a Kapton™, Mylar™ or Upilex™ film, and a patterned metallic coating in particular a vacuum deposited aluminium (VFA) coating. The upper layer may comprise a patterned polyimide film loaded with inorganic carbon, in particular Black Kaptop™. Said patterned frequency-selective structure may be obtainable by metallic deposition and etching or cutting said pattern, in particular by laser etching or cutting. The patterned FSS sheet may have a pattern of unconnected square patches arranged in a grid.

### SUMMARY OF THE PRESENT INVENTION

An aspect of the present invention seeks to provide tape for mitigating passive intermodulation, the tape including: a metalized polymer substrate; an adhesive layer bonded to a first face of the substrate; and, a plurality of apertures extending through the substrate and the adhesive layer, such that when the tape is adhered to a surface using the adhesive layer, the apertures allow fluid communication between the surface and a second face of the substrate opposing the first face.

In one embodiment, the tape is at least one of: self-draining; and, self-drying.

In one embodiment, the adhesive layer is a pressure sensitive adhesive layer.

In one embodiment, the metalized polymer is non-conductive.

In one embodiment, the metalized polymer includes at least one of: aluminium; iron; steel; nickel; gold; and, silver.

In one embodiment, the metalized polymer includes a ferromagnetic material.

In one embodiment, at least some of the apertures are arranged in a line.

In one embodiment, the line is parallel to an edge of the tape.

In one embodiment, the line is aligned with a centerline of the tape located between opposing edges of the tape.

In one embodiment, the apertures are arranged in a plurality of lines.

In one embodiment, the apertures are arranged in a grid.

In one embodiment, at least some of the apertures are arranged in staggered diagonal lines.

In one embodiment, the apertures are arranged along the length of the tape, and wherein adjacent apertures separated from an edge of the tape by different distances.

In one embodiment, adjacent apertures are located on alternating sides of the tape.

In one embodiment, a width of the tape between opposing edges of the tape is at least one of: less than about 300 mm; less than about 150 mm; between 35 mm and 145 mm; between 45 mm and 135 mm; between 55 mm and 125 mm; between 65 mm and 115 mm; between 75 mm and 105 mm; between 85 mm and 95 mm; around 50 mm; around 90 mm; around 100 mm; and, around 150 mm.

In one embodiment, the apertures are separated from an edge of the tape by at least a predetermined edge separation distance.

In one embodiment, the predetermined edge separation distance is at least one of: less than 40 percent of the width of the tape; between 5 and 35 percent of the width of the tape; between 10 and 30 percent of the width of the tape; and, around 20 percent of the width of the tape.

In one embodiment, the predetermined edge separation distance is at least one of: between 5 mm and 35 mm; between 10 mm and 30 mm; between 15 mm and 25 mm; around 10 mm; and, around 20 mm.

In one embodiment, adjacent apertures are spaced apart by at least a predetermined spacing distance.

In one embodiment, the predetermined spacing distance is at least one of: less than 30 percent of the width of the tape; between 5 and 25 percent of the width of the tape; between 10 and 20 percent of the width of the tape; and, around 15 percent of the width of the tape.

In one embodiment, the predetermined spacing distance is at least one of: between 5 mm and 25 mm; between 10 mm and 20 mm; and, around 15 mm.

In one embodiment, the apertures are in the shape of at least one of: a slot; a rectangle; an oblong; a square; a triangle; and a circle.

In one embodiment, the apertures have a minimum width that is at least one of: less than 30 percent of the width of the tape; between 5 and 25 percent of the width of the tape; between 10 and 20 percent of the width of the tape; and, around 15 percent of the width of the tape.

In one embodiment, the apertures have a minimum width that is at least one of: between 1 mm and 9 mm; between 2 mm and 8 mm; between 3 mm and 7 mm; between 4 mm and 6 mm; and, around 5 mm.

In one embodiment, the second face of the substrate is reflective.

In another aspect, the present invention seeks to provide a method for producing tape for mitigating passive intermodulation, the method including: analyzing a RF signal that is to be mitigated; determining properties of the tape to mitigate the RF signal; and, producing the tape in accordance with the determined properties.

In one embodiment, analyzing a RF signal includes: identifying a RF signal;
determining frequency of the RF signal; and, determining attenuation of the RF signal.

Method according to either claim 26 or 27, wherein determining properties of the tape includes: determining width of the tape; determining shape of the apertures; determining width of the apertures; and, determining layout of the apertures.

In one embodiment, producing the tape includes: providing a first layer, wherein the first layer is a metalized polyester substrate; bonding a second layer to a first face of the first layer, wherein the second layer is an adhesive layer; and, forming a plurality of apertures through the first and second layers.

It will be appreciated that the broad forms of the invention and their respective features can be used in conjunction, interchangeably and/or independently, and reference to separate broad forms is not intended to be limiting.

### BRIEF DESCRIPTION OF THE DRAWINGS

Various examples and embodiments of the present invention will now be described with reference to the accompanying drawings, in which:

FIG. 1A is a schematic plan view of an example of a tape;

FIG. 1B is a schematic side view of the tape of FIG. 1A;

FIG. 2 is a flow chart showing an example of a method to produce the tape;

FIGS. 3A-3G are schematic plan views of examples of how apertures may be arranged on the tape; and,

FIG. 4 is a schematic plan view of examples of the form of apertures used in the tape.

### DETAILED DESCRIPTION OF THE PREFERRED EMBODIMENTS

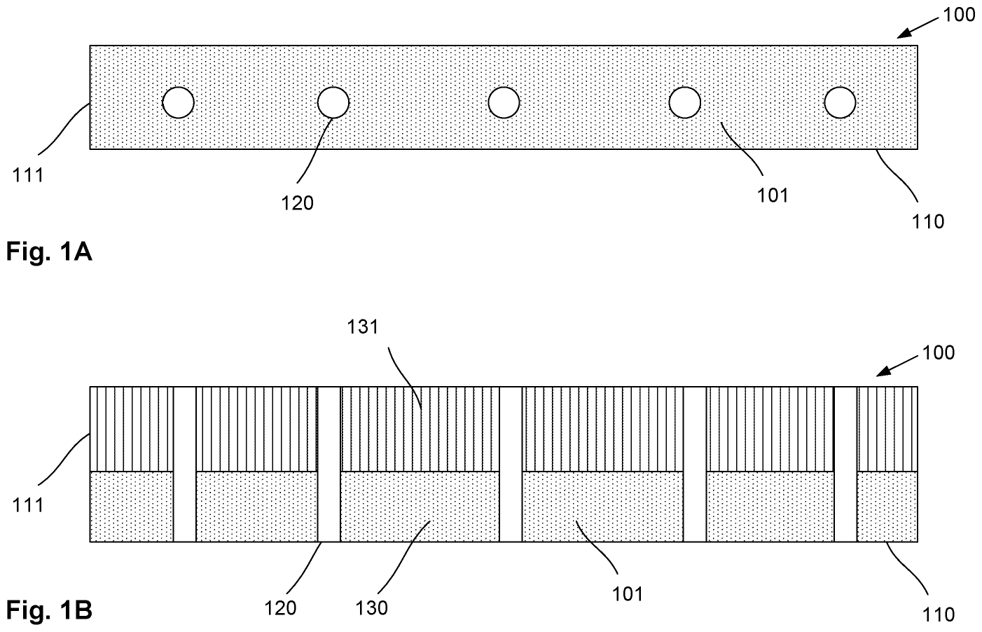

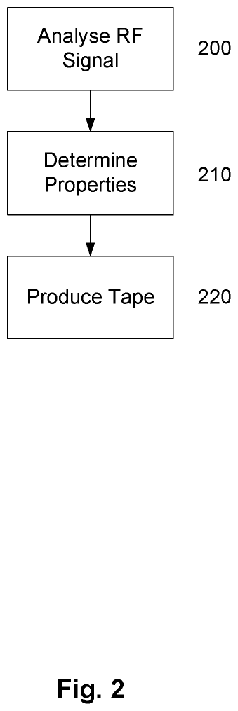

An example of tape for mitigating passive intermodulation will now be described with reference to FIGS. 1A and 1B.

In broad terms, the tape 100 includes a metalized polymer substrate 110, an adhesive layer 120 bonded to a first face 111 of the substrate, and a plurality of apertures 130 extending through the substrate 110 and the adhesive layer 120. As a result of this configuration, when the tape 100 is adhered to a surface using the adhesive layer 120, the apertures 130 allow fluid communication between the surface and a second face 112 of the substrate opposing the first face 111. It should be appreciated that the thickness of the tape 100 in FIG. 1B is not to scale, and has been exaggerated to allow visualisation of the substrate 110 and adhesive layer 120.

Accordingly, it will be appreciated that the tape 100 can be applied to surfaces of objects in a radio system for mitigating passive intermodulation, but in contrast to conventional PIM barrier tapes or the like, the apertures 130 can allow water to drain from under the tape, and also allow exposure to air to assist in drying the moisture, thus minimizing corrosion of any metal structure that the tape 100 is covering.

As will be described in further detail below, the apertures 130 may be configured to achieve this benefit without compromising the important radio frequency (RF) characteristics of the tape 100. Thus, the tape 100 can mitigate traditional corrosion problems associated with trapped moisture trapped while exhibiting radio frequency properties comparable to conventional PIM barrier tapes.

In one embodiment, the tape 100 is at least one of self-draining; and, self-drying. Conventional PIM barrier tapes can allow for increased corrosion of the structure the PIM barrier tape is attempting to protect by trapping additional moisture close to the structure. If the PIM barrier tape includes multiple layers, the rate of corrosion can be increased due to additional moisture being trapped between layers of the PIM barrier tape. The tape 100 addresses this issue by including a plurality of apertures 130, allowing the moisture to self-drain or self-dry.

In one embodiment, the adhesive layer 120 is a pressure sensitive adhesive layer 120. The pressure sensitive adhesive layer 120 requires the user to place pressure on the tape 100 before the adhesive of the tape 100 will stick to another object. This allows the user to place the tape 100 with more precision that traditional PIM barrier tapes. If the tape 100 does not require pressure to stick to another object, a user is more likely to place the tape 100 in an incorrect position and subsequently damage the adhesive layer while attempting to reposition the tape 100, resulting in wasted tape and a less effective PIM solution. By requiring the user to place pressure on the tape 100, the user can readjust the position of the tape 100 so that it most effectively protects the structure.

In one embodiment, the metalized polymer layer and adhesive layer 120 are bonded together. Bonding the layers together allows for the tape 100 to be more resilient to wear and reduces the rate of corrosion, resulting in more durable and longer lasting tape 100. By bonding the layers together, the layers are less likely to split apart from each other and compromise the effectiveness of the tape 100. Further, by bonding the layers together, it is less likely that moisture can become trapped between the layers and reduces the rate of corrosion on the structure and water damage to the tape 100.

In one embodiment, the metalized polymer is non-conductive. Traditional PIM barrier tapes utilise metal layers which are likely to be electrically conductive and become radiators of RF energy, which may include PIM signals. Further PIM signals can be generated if loose metal components contact each other. By including a non-conductive metalized polymer, the tape 100 does not include electrically conductive elements that may produce unwanted PIM signals, increasing the effectiveness of the tape 100. The polymer material used in forming the metalized polymer could be of any appropriate form, but in one example, is a metalized polyester, or similar.

In one embodiment, the metalized polymer includes a ferromagnetic material. The metalized polymer may also include at least one of: aluminium; iron; steel; nickel; gold; and, silver. By including ferromagnetic materials, iron, steel, cobalt or nickel, the metalized polymer may include magnetic properties. By including aluminium, gold or silver, the metalized polymer has additional resistance to corrosion.

In one embodiment, at least some of the apertures 130 are arranged in a line. The line may also be parallel to an edge of the tape. The line may also be aligned with a centreline of the tape located between opposing edges of the tape. The apertures 130 may also be arranged in a plurality of lines.

By arranging the apertures 130 in the form of a line (or plurality of lines), it allows the tape 100 to minimise the number of apertures 130 required to allow for self-draining, while minimising the impact to the structural integrity of the tape 100, and the PIM mitigation provided. Further, as the apertures 130 would be included in a continuous line (or lines) along the tape 100, it allows the user to cut the tape 100 in almost any length without resulting in an interruption to any pattern, which otherwise may result in reduced effectiveness of the self-draining or PIM mitigation.

In one embodiment, the apertures 130 are arranged in a grid. The apertures 130 may also be arranged in staggered diagonal lines. The apertures 130 may also be arranged along the length of the tape 100, where at least some of the apertures are arranged in staggered diagonal lines. The apertures 130 may also be arranged along the length of the tape 100, where adjacent apertures 130 separated from an edge of the tape 100 by different distances. The adjacent apertures 130 may also be located on alternative sides of the tape 100.

By arranging apertures 130 in a grid (or in a staggered arrangement), allows the tape 100 to have a more even distribution of apertures 130 across the entire surface area of the tape 100. Therefore, more areas of the tape 100 can self-drain as more sections of the tape 100 are sufficiently close to an aperture 130 to allow self-draining to occur. By maximising the self-draining properties of the tape 100, it allows the tape 100 to be used for a longer period of time in high humidity or wet climates while minimising any corrosive effects on the protected structure.

In one embodiment, the width of the tape 100 between opposing edges of the tape is at least one of: less than about 300 mm; less than about 150 mm between 35 mm and 145 mm; between 45 mm and 135 mm; between 55 mm and 125 mm; between 65 mm and 115 mm; between 75 mm and 105 mm; between 85 mm and 95 mm; around 50 mm; around 90 mm; and, around 100 mm. The width of the tape 100 is critical to optimising the amount of tape 100 required to protect the structure and ensuring optimal placement of the apertures 130 within the tape 100. If the tape 100, is approximately 50 mm, 90 mm or 100 mm wide, it allows for a minimal amount of wasted tape while including the optimal aperture 130 layout, without becoming unwieldy to the user. Although tape widths of 150 mm or less are generally preferred, wider tapes may be used depending on requirements, and in some embodiments, the width of the tape 100 may be 300 mm.

In one embodiment, the apertures 130 are separated from an edge of the tape 100 by at least a predetermined edge separation distance. The predetermined edge separation distance may also be at least one of: less than 40 percent of the width of the tape; between 5 and 35 percent of the width of the tape; between 10 and 30 percent of the width of the tape; and, around 20 percent of the width of the tape. The predetermined edged separation distance may also be at least one of between 5 mm and 35 mm, between 10 mm and 30 mm, between 15 mm and 25 mm; around 10 mm; and, around 20 mm.

By maintaining a predetermined distance between the apertures 130 and the edge of the tape 100, it allows for the tape 100 to overlap while wrapping around a structure without compromising the effectiveness of the tape 100. For example, if there is no predetermined distance, the user may cover a portion of the apertures 130, reducing their effectiveness to mitigate PIM and ability to self-drain or self-dry. In addition, if apertures 130 are included too close to the edge of the tape, it may compromise the tape's 100 structural integrity, leading to damage when installing and overall reduced durability. By allowing a user to overlap the tape when installing, it maintains the effectiveness of the tape 100 while allowing the user to have a larger margin of error, allowing the tape to be more easily installed.

In one embodiment, the apertures 130 are in the shape of one of at least one of: a slot; a rectangle; an oblong; a square, a triangle; and, a circle. The form of the apertures 130 can influence the behaviour of RF signals in and around the apertures 130, and is highly frequency dependent. In particular, slots, circles, oblongs and rectangles cover the largest variety of RF signals and frequencies for a given aperture 130 diameter when compared to other aperture 130 forms. Circles and oblongs can allow for more durable tape as the sharp angles required for rectangles and slots can introduce additional points where the tape 100 is more likely to structurally fail.

Circular apertures are less transparent to RF radiation compared to other shapes with the same area but larger maximum dimensions, due to the effective waveguide properties of circular apertures.

In one embodiment, the apertures 130 have a minimum width that is at least one of: less than 30 percent of the width of the tape 100; between 5 and 25 percent of the width of the tape 100; between 10 and 20 percent of the width of the tape 100; and, around 15 percent of the width of the tape 100. The apertures 130 may also have a minimum width that is at least one of: between 1 mm and 9 mm, between 2 mm and 9 mm; between 3 mm and 7 mm; between 4 mm and 6 mm; and, around 5 mm. If the apertures are 5 mm in width, it allows for self-draining/self-drying to occur for substantially the entire region under the tape 100, without adversely affecting the structural integrity of the tape 100, whilst maintaining the PIM reduction capabilities.

Thus, the optimal width of the apertures 130 minimises the effect of PIM and maintains the structural integrity of the tape 100. If the apertures 130 are a width that exceeds 30 percent of the width of the tape 100, there is an increased risk that the tape 100 will structurally fail within the normal course of wear and tear, whereas if the apertures are too small, insufficient draining and/or drying will occur. The apertures 130 are capable of covering all commonly used and emerging mobile communications networks (operating between frequencies of 200 MHz to 6 GHz) while the aperture 130 width is approximately 5 mm.

In one embodiment, the second face 112 of the substrate 110 is reflective. The second face 112 could be made reflective by including brightly coloured aluminium oxide, silver alloy, stainless steel or other reflective metals on the surface of the second face 112. If the second face 112 of the substrate 110 is reflective, it allows for a user to clearly identify the tape 100 from a distance, making it easier to inspect, remove or replace after the tape 100 has been applied. The reflective surface also more clearly shows if the tape 100 has been damaged. Additionally, the reflective surface may reduce damage to the tape 100, if the tape 100 is expected to spend extensive periods exposed to sunlight. Reflective properties also make the tape 100 less appealing to birds and other pests, acting as a deterrent.

In one embodiment, the method for producing tape 100 for mitigating PIM includes: analysing a RF signal that is to be mitigated; determining properties of the tape to mitigate the RF signal; and, producing tape in accordance with the determined properties. Analysing the RF signal may further include: identifying a RF signal, determining frequency of the RF signal; and determining attenuation of the RF signal. Determining properties of the tape 100 may further include: determining width of the tape 100; determining shape of the apertures 130; determining width of the apertures 130; and, determining layout of the apertures 130. Producing the tape may further include: providing a first layer, where the first layer is a metalized polyester substrate 110; bonding a second layer to the first face 111 of the first layer, wherein the second layer is an adhesive layer; and, forming a plurality of apertures 130 through the first and second layers.

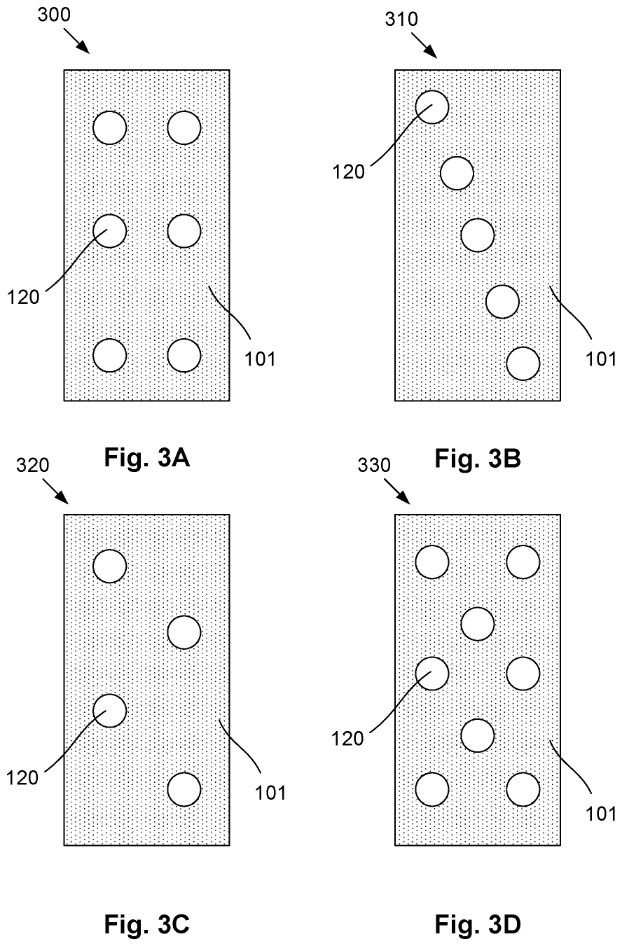

FIG. 2 shows a method for how a user may produce the tape 100. At step 200, the user first analyses the RF signals that may be interfering with the structure. This may include identifying the frequency and attenuation of the signal. At step 210, the user may determine the properties of the tape 100 to be used to counter the identified RF signal in step 200. This may include determining the width of tape 100 and the width/shape/layout of the apertures 130 to be used. At step 220, the user may then produce the tape 100 in accordance with the properties determining in step 210. This may include tape 100 with a first layer 111, including a metalized substrate 110, second layer 112, including an adhesive layer and forming a plurality of apertures 130 through the first 111 and second 112 layers.

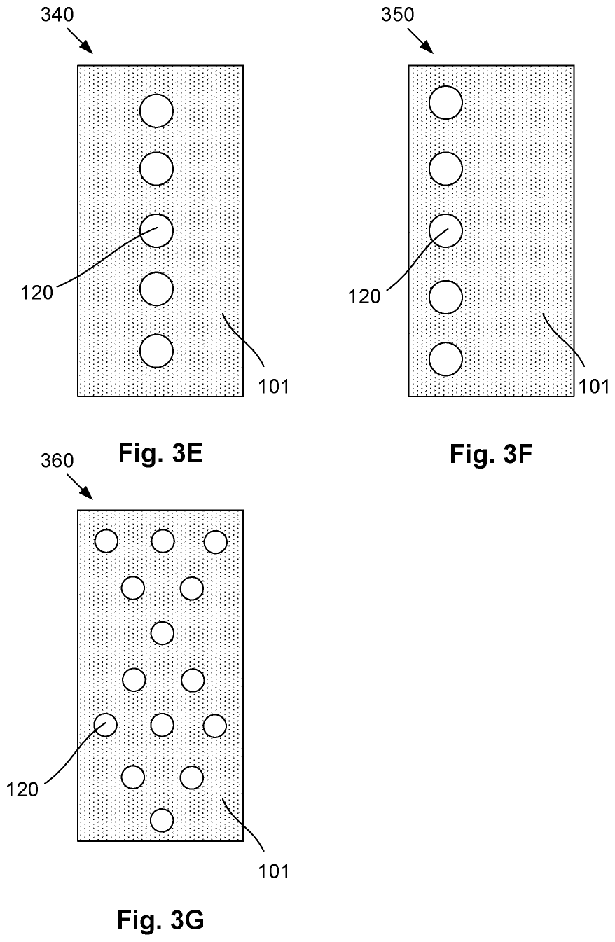

FIGS. 3A to 3G show examples of how the apertures 130 may arranged along the tape 100. FIG. 3A is an example of apertures in the form of a rectangular grid, 3B shows a diagonal line, 3C shows a staggered diagonal line, 3D shows a double staggered diagonal line, 3E shows a line of apertures 130 down the centreline of the tape 100, 3F shows a line of apertures 130 not down the centreline of the tape 100 and 3G shows the combination of a line of apertures 130 down the centreline of the tape 100 and a double staggered diagonal of apertures 130.

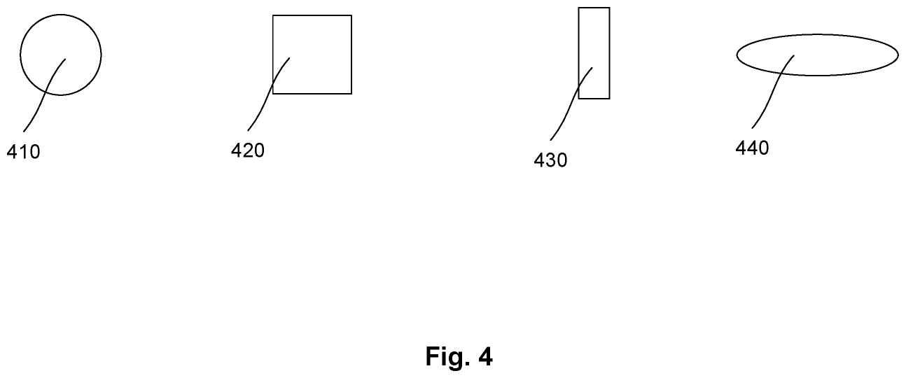

FIG. 4 shows examples of the forms that the apertures 130 may take, including a circle 410, a square 420, a rectangular slot 430 and an ovoid 440.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers. As used herein and unless otherwise stated, the term “approximately” means±20%.

It must be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

It will of course be realised that whilst the above has been given by way of an illustrative example of this invention, all such and other modifications and variations hereto, as would be apparent to persons skilled in the art, are deemed to fall within the broad scope and ambit of this invention as is herein set forth.

The claims defining the invention are as follows:

1. Tape for mitigating passive intermodulation, the tape including:
a) a metalized polymer substrate;
b) an adhesive layer bonded to a first face of the substrate; and,
c) a plurality of apertures extending through the substrate and the adhesive layer, such that when the tape is adhered to a surface using the adhesive layer, the apertures allow fluid communication between the surface and a second face of the substrate opposing the first face.

2. Tape according to claim 1, wherein the tape is at least one of:
a) self-draining; and,
b) self-drying.

3. Tape according to any one of the preceding claims, wherein the adhesive layer is a pressure sensitive adhesive layer.

4. Tape according to any one of the preceding claims, wherein the metalized polymer is non-conductive.

5. Tape according to any one of the preceding claims, wherein the metalized polymer includes at least one of:
a) aluminium;
b) iron;
c) steel;
d) nickel;
e) gold; and,
f) silver.

6. Tape according to any one of the preceding claims, wherein the metalized polymer includes a ferromagnetic material.

7. Tape according to any one of the preceding claims, wherein at least some of the apertures are arranged in a line.

8. Tape according to claim 7, wherein the line is parallel to an edge of the tape.

9. Tape according to claim 8, wherein the line is aligned with a centerline of the tape located between opposing edges of the tape.

10. Tape according to any one of claims 7 to 9, wherein the apertures are arranged in a plurality of lines.

11. Tape according to claim 10, wherein the apertures are arranged in a grid.

12. Tape according to claim 10, wherein at least some of the apertures are arranged in staggered diagonal lines.

13. Tape according to any one of the preceding claims, wherein the apertures are arranged along the length of the tape, and wherein adjacent apertures separated from an edge of the tape by different distances.

14. Tape according to claim 13, wherein adjacent apertures are located on alternating sides of the tape.

15. Tape according to any one of the preceding claims, wherein a width of the tape between opposing edges of the tape is at least one of:
a) less than about 300 mm;
b) less than about 150 mm;
c) between 35 mm and 145 mm;
d) between 45 mm and 135 mm;
e) between 55 mm and 125 mm;
f) between 65 mm and 115 mm;
g) between 75 mm and 105 mm;
h) between 85 mm and 95 mm;
i) around 50 mm;
j) around 90 mm;
k) around 100 mm; and,
l) around 150 mm.

16. Tape according to any one of the preceding claims, wherein the apertures are separated from an edge of the tape by at least a predetermined edge separation distance.

17. Tape according to claim 16, wherein the predetermined edge separation distance is at least one of:
a) less than 40 percent of the width of the tape;
b) between 5 and 35 percent of the width of the tape;
c) between 10 and 30 percent of the width of the tape; and,
d) around 20 percent of the width of the tape.

18. Tape according to either claim 16 or claim 17, wherein the predetermined edge separation distance is at least one of:
a) between 5 mm and 35 mm;
b) between 10 mm and 30 mm;
c) between 15 mm and 25 mm;
d) around 10 mm; and,
e) around 20 mm.

19. Tape according to any one of the preceding claims, wherein adjacent apertures are spaced apart by at least a predetermined spacing distance.

20. Tape according to claim 19, where the predetermined spacing distance is at least one of:
a) less than 30 percent of the width of the tape;
b) between 5 and 25 percent of the width of the tape;
c) between 10 and 20 percent of the width of the tape; and,
d) around 15 percent of the width of the tape.

21. Tape according to either claim 19 or claim 20, wherein the predetermined spacing distance is at least one of:
a) between 5 mm and 25 mm;
b) between 10 mm and 20 mm; and,
c) around 15 mm.

22. Tape according to any one of the preceding claims, wherein the apertures are in the shape of at least one of:
a) a slot;
b) a rectangle;
c) an oblong;
d) a square;
e) a triangle; and
f) a circle.

23. Tape according to any one of the preceding claims, wherein the apertures have a minimum width that is at least one of:
a) less than 30 percent of the width of the tape;
b) between 5 and 25 percent of the width of the tape;
c) between 10 and 20 percent of the width of the tape; and,
d) around 15 percent of the width of the tape.

24. Tape according to any one of the preceding claims, wherein the apertures have a minimum width that is at least one of:
a) between 1 mm and 9 mm;
b) between 2 mm and 8 mm;
c) between 3 mm and 7 mm;
d) between 4 mm and 6 mm; and,
e) around 5 mm.

25. Tape according to any one of the preceding claims, wherein the second face of the substrate is reflective.

26. A method for producing tape for mitigating passive intermodulation, the method including:
a) analyzing a RF signal that is to be mitigated;
b) determining properties of the tape to mitigate the RF signal; and,
c) producing the tape in accordance with the determined properties.

27. Method according to claim 26, wherein analyzing a RF signal, includes:
a) identifying a RF signal;
b) determining frequency of the RF signal; and,
c) determining attenuation of the RF signal.

28. Method according to either claim 26 or 27, wherein determining properties of the tape includes:
a) determining width of the tape;
b) determining shape of the apertures;
c) determining width of the apertures; and,
d) determining layout of the apertures.

29. Method according to any one of claims 26 to 28, wherein producing the tape includes:
a) providing a first layer, wherein the first layer is a metalized polyester substrate;
b) bonding a second layer to a first face of the first layer, wherein the second layer is an adhesive layer; and,
c) forming a plurality of apertures through the first and second layers.
